(19) United States
(12) Patent Application Publication
(10) Pub. No.: US 2023/0040638 A1
(43) Pub. Date: Feb. 9, 2023

(54) METHOD AND SYSTEM FOR AUTOMATICALLY SCHEDULING SERVICE PROVIDER APPOINTMENT AT TARGET LOCATION

(71) Applicant: Remark Visions LLC, Capistrano Beach, CA (US)

(72) Inventors: Mark Alexander Gustafson, Capistrano Beach, CA (US); Michael Robert Klinker, Hollis, NH (US); Rudolf F. Hattenkofer, Buch am Eribach (DE)

(21) Appl. No.: 17/881,118

(22) Filed: Aug. 4, 2022

Related U.S. Application Data
(60) Provisional application No. 63/230,612, filed on Aug. 6, 2021.

(51) Int. Cl. G06Q 10/10

(52) U.S. Cl. CPC G06Q 10/1095

(57) ABSTRACT

A method of automatically scheduling a service provider appointment at a target location is provided. The method includes receiving a first calendar schedule of a first service provider, and a target assignment that includes a target area, a target assignment type, and the target location. A first time slot can be identified in the first calendar schedule. A comprehensive operation time associated with the target assignment and the first service provider can be determined based on at least an estimated travel time and an estimated operation time to perform the target assignment based on the target area and the target assignment type. The method further includes notifying the comprehensive operation time to a user. Related systems and computer program products are also provided.

### CROSS-REFERENCE TO RELATED APPLICATIONS

The present application claims priority under 35 U.S.C. § 119 to U.S. Provisional Application No. 63/230,612 entitled “METHOD AND SYSTEM FOR AUTOMATICALLY SCHEDULING SERVICE PROVIDER APPOINTMENT AT TARGET LOCATION” filed on Aug. 6, 2021, which is hereby expressly incorporated by reference in its entirety.

### BACKGROUND

This disclosure relates generally to the technical field of calendar scheduling. In particular, the disclosure relates to identifying service providers for performing a target assignment based on a calendar schedule. Calendaring software can include an electronic version of a calendar associated with an individual or an organization. The calendaring software can include location, address book, time zone, contact list, etc. associated with an individual (e.g., a service provider). In some implementations, the calendaring software can be configured to communicate with an external program via an application programming interface (API). For example, the calendaring software can request various information associated with the individual (e.g., calendar schedule, location, etc.) from the external program. In some implementations, the calendaring software can be a web application that can allow one or more pre-approved users to access information therein.

### SUMMARY

Various aspects of the disclosed subject matter may provide one or more of the following capabilities.

In some implementations, a method of automatically scheduling a service provider appointment at a target location is provided. The method can include receiving data characterizing a first calendar schedule of a first service provider, and data characterizing a target assignment that can include a target area, a target assignment type, and the target location. The method can also include identifying a first time slot in the first calendar schedule. The first time slot can be temporally located between a previous appointment located at a first location and a following appointment located at a second location; The method can further include determining a comprehensive operation time associated with the target assignment and the first service provider based on at least an estimated travel time including a first travel time from the first location to the target location and a second travel time from the target location to the second location, and an estimated operation time to perform the target assignment based on the target area and the target assignment type. The method can further include notifying the comprehensive operation time to a user.

One or more of the following features can be included in any feasible combination.

In some implementations, the method can further include receiving data characterizing calendar schedules and service preferences associated with a plurality of service providers. The plurality of service providers can include the first service provider. The method can also include selecting the first service provider from the plurality of service providers based on a first set of service preferences associated with the first service provider. The first set of service preferences can include at least one of a maximum travel time, a maximum travel distance, an operation cost, or an operating schedule associated with the first service provider.

In some implementations, selecting the first service provider can further include determining that the first travel time from the first location to the target location or a second travel time from the target location to the second location is below a preferred travel time included in the first set of service preferences. In some implementations, the method can further include determining an operation cost associated with performing the target assignment based on one or more of the estimated travel time, the estimated operation time, the target area, or the comprehensive operation time; and providing the operation cost to the user.

In some implementations, determining the operation cost can include calculating a product of a difference between the estimated travel time and a free travel time, as multiplied by a cost per travel time, and calculating a product of the target area and a cost per unit target area. The first set of service preferences can include the free travel time, the cost per travel time and the cost per unit target area. In some implementations, determining the comprehensive operation time can further include determining that a distance between the target location and the first location is less than a preferred travel distance of the first set of service preferences. In some implementations, notifying the comprehensive operation time can include notifying the user that the first provider is incapable of performing the target assignment when the comprehensive operation time is greater than a length of time of the first time slot, or notifying the user that the first provider is capable of performing the target assignment when the comprehensive operation time is less than the length of time of the first time slot.

In some implementations, the first travel time from the first location to the target location can be based on a first predetermined time as measured by historical Global Positioning System (GPS) traffic data from the first location to the target location during a first portion of the first time slot. The second travel time from the target location to the second location can be based on a second predetermined time as measured by historical GPS data from the target location to the second location during a second portion of the first time slot. In some implementations, the estimated travel time can include at least one of a first travel buffer time prior to the first travel time or a second travel buffer time after the second travel time. In some implementations, the estimated operation time to perform the target assignment can include a base operation time and a target-area-based operation time. The base operation time can be associated with the target assignment type, and the target-area-based operation time can be a product of the target area and a time per unit target area.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings.

FIG. 1 is a flow chart of an exemplary method for scheduling a service appointment;

FIG. 2 illustrates an exemplary operation of the scheduling service;

FIG. 3 is an exemplary illustration of a proposed comprehensive operation time for an available time slot in a service provider's calendar schedule;

FIG. 4 is an exemplary illustration of multiple proposals for comprehensive operation times for an available time slot in a service provider's calendar schedule;

FIG. 5 is an exemplary illustration of a proposed comprehensive operation time that includes travel buffer time;

FIG. 6 illustrates an exemplary schematic for determination of estimated travel fee associated with a travel time;

FIG. 7 is an exemplary illustration of a proposed operation time having a time duration greater than a time slot;

FIG. 8 is an exemplary illustration of a proposed comprehensive operation time having a time duration greater than a time slot;

FIG. 9 is an exemplary illustration of multiple proposals for comprehensive operation times for an available time slot;

FIG. 10 illustrates exemplary selection of service providers for a target location 1000 based on maximum travelling distances; and

FIG. 11 illustrates an exemplary computation device for scheduling a service appointment.

### DETAILED DESCRIPTION

Scheduling a service appointment by a user to perform a target assignment can depend on multiple factors (e.g., type and location of target assignment, availability of service providers, etc.). This can be a challenging task. For example, in order to schedule a service appointment, the user may have to identify the potential service providers that are capable of performing the target assignment, contact the identified service providers (e.g., via phone, email, etc.) and determine their availability to complete the target assignment. Scheduling an appointment by identifying potential service providers and contacting them individually can be challenging, cumbersome and inefficient. For example, the user may not have access to the electronic calendar of the service providers, and as a result may contact service providers that are unavailable or prefer not to perform the target assignment (e.g., based on service provider preferences). Even if the user can access the electronic calendars of the service providers (e.g., via a third party repository of service providers' electronic calendar), the user may not be able to identify service providers suitable for the target assignment (e.g., the location of the target assignment may be outside service provider's preferred service area, cost of hiring the service provider may be greater than the user's budget, etc.).

Some implementations of the current subject matter allows for identification of service providers capable of performing a target assignment based on availability of the service providers, service provider preferences (e.g., maximum travel distance or maximum travel time preferred by the service provider), and user preferences (e.g., type and location of target assignment, target assignment area, etc.). The availability of a service provider can be based on available time slots (e.g., identified from the service provider's electronic calendar), travel time to and from the target location. In some implementations, the target assignment budget for a given service provider (e.g., selected from the available service providers) can be determined based on the predetermined cost associated with the target assignment, target assignment area and travel time/distance of the service provider to perform the target assignment.

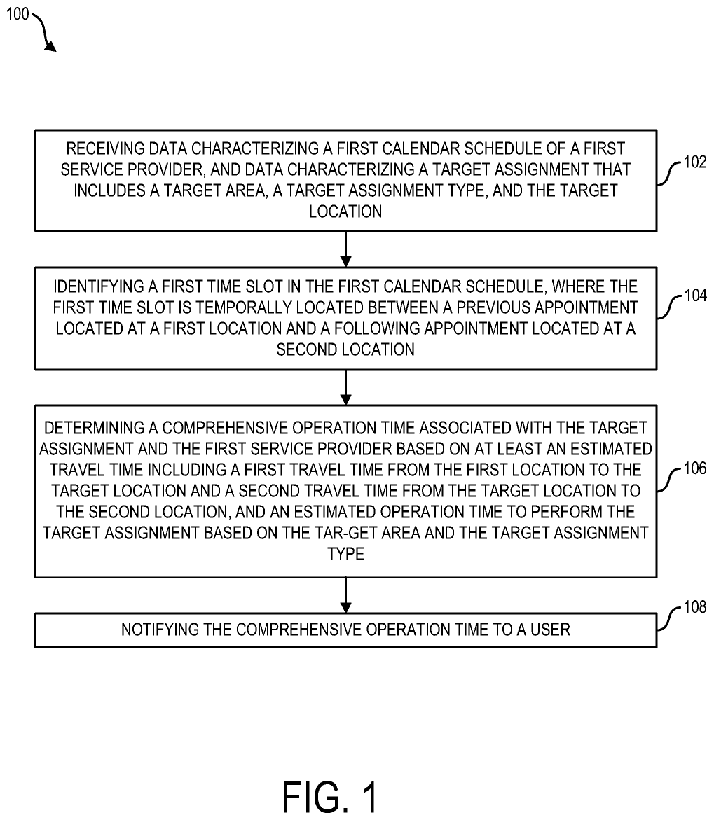

FIG. 1 a flow chart of an exemplary method for scheduling a service appointment. At 102, data characterizing a first calendar schedule of a first service provider and data characterizing a target assignment that includes a target area (e.g., area of the property associated with the target assignment), a target assignment type, and the target location is received (e.g., by a processor of a computing device). In some implementation, the first calendar schedule can be retrieved (e.g., automatically) from the electronic calendar of the first service provider. The first calendar schedule can include the time, duration, and location of the various appointments associated with the first service provider. Information associated with the target assignment (e.g., target area, target assignment type, target location, etc.) can be provided by user (e.g., when the user is attempting to schedule an appointment).

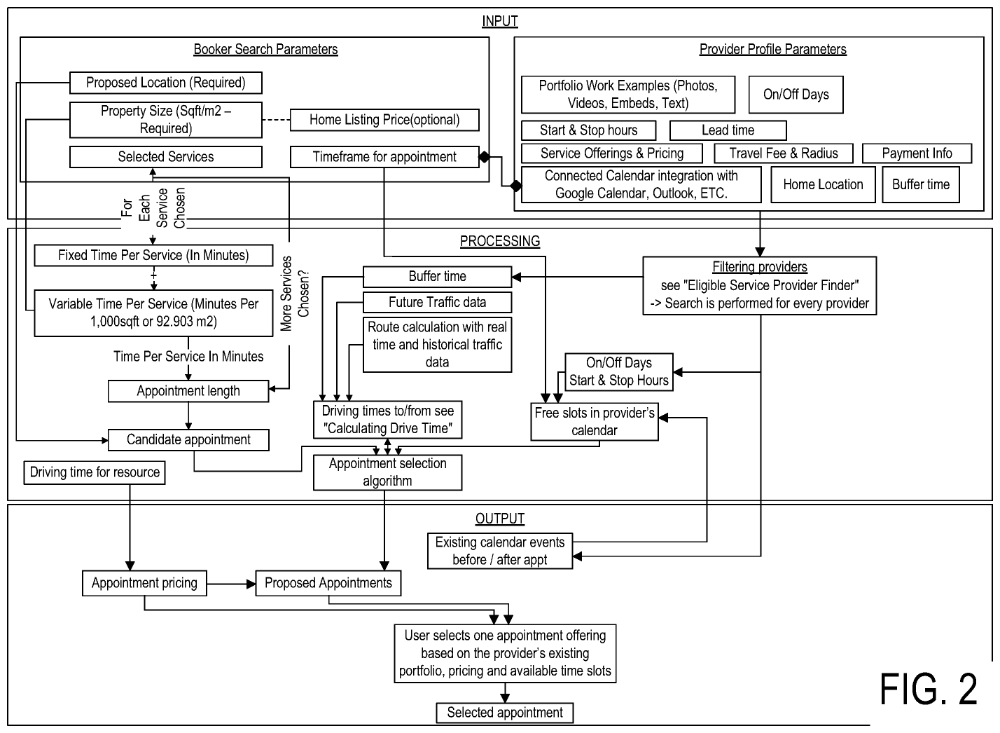

FIG. 2 illustrates an exemplary operation of the scheduling service. The scheduling service receives inputs that can include information provided by the user (also referred to as the booker) that can include one or more of address of the target location, a property size associated with the target location, a target assignment type, a timeframe for scheduling the target assignment, and listed price of the target location. The inputs can include service preferences provided by the service provider. For example, the service preferences can include one or more of a home location, a preferred distance/time of travel (e.g., a maximum distance/time of travel from a predetermined location [e.g., home location]) to provide a service, operation cost (e.g., travel cost, cost of performing the target assignment, etc.), a buffer time to be added to the overall travel time, service offering and pricing, operating scheduling (e.g., on/off days, start and stop hours, etc.), a professional portfolio with examples (e.g., photos, videos, embeds, text, etc.) of professional work, data associated with the service provider's electronic calendar, etc.

Based on the inputs, the scheduling service can calculate recommendations for proposed appointments with one or more service providers. Additionally, the recommendations can include the time and duration of the proposed appointment and the corresponding operation cost associated with the proposed appointments. Current subject matter describes exemplary methods for calculating the proposed appointments.

In some implementations, data characterizing calendar schedules and service preferences associated with a plurality of service providers can be received and the first service provider can be selected from the plurality of service providers. For example, the first service provider can be selected from the plurality of service providers based on a first set of service preferences associated with the first service provider (e.g., service preferences received at step 102). The service preferences can include at least one of a maximum travel time, a maximum travel distance, an operation cost, or an operating schedule associated with the first service provider. In some implementations, the service preferences can include target assignment type (e.g., indicative of the work the target assignment entails).

Returning back to FIG. 1, at step 104, a first time slot in the first calendar schedule can be identified. The first calendar schedule received at step 102 can include multiple available time slots. A given time slot (e.g., first time slot) can be defined as being temporally located between a previous appointment and a following appointment. The previous appointment can be associated with a first location and the following appointment can be associated with a second location. In some implementations, the first appointment can be defined as a start from home (e.g. at the beginning of the work day) and the first location can be the home address. In some implementations, the second appointment can be defined as a return to home (e.g. at the end of the work day) and the second location is the home address.

In some implementations, a service provider (e.g., first service provider) can be selected from the plurality of service providers only if the distance between a predetermined location (e.g., home location, first location of the previous appointment, second location of the following appointment, etc.) and the target location is less than the maximum travel distance preferred by the service provider and/or if the time of travel to the target location (e.g., from the first location, home location, etc.) and from the target location (e.g., to the second location, home location, etc.) is less than a maximum travel time. The maximum travel distance/time can be included in the service preferences provided by the service provider. In some implementations, a service provider (e.g., first service provider) can set the service provider settings that can allow for usage of the current location of the service provider (e.g., determined using GPS) as the predetermined location from where various travel attributes (e.g., travel time, travel distance, etc.) to the target location are calculated. For example, when the user is booking the services of the service provider on the day of the target assignment, various travel attributes can be calculated based on the current location (e.g., instead of the home location).

Returning back to FIG. 1, at step 106, an estimate of a comprehensive operation time that may be taken by the first service provider to perform the target assignment can be determined. The comprehensive operation time can include an estimated travel time (e.g., which includes first travel time from the first location to the target location and a second travel time from the target location to the second location), and an estimated operation time to perform the target assignment. In some implementations, the estimated operation time can include a base operation time and a target-area-based operation time. The base operation time can be indicative of the time taken to set up the equipment for performing the target assignment. The based operation time can be based on the target assignment type. The target based operation time can be calculated by multiplying the square footage of the target location with a predetermined time per unit target area for performing the target assignment.

In some implementations, a given target site can include multiple target assignments. For example, a target site with a given target area can include multiple target assignments (e.g., a first target assignment, a second target assignment, a third target assignment and a fourth target assignment). Each of the target assignment can be associated with a corresponding base operation time (or fixed time) and a target-area-based operation time. As described above, estimated operation time can be calculated for each of the assignment (e.g., estimated operation time=base operation time+target-are-based operation time*target area). A total estimated operation time can be the sum of each of the estimated operation time (associated with the multiple assignments).

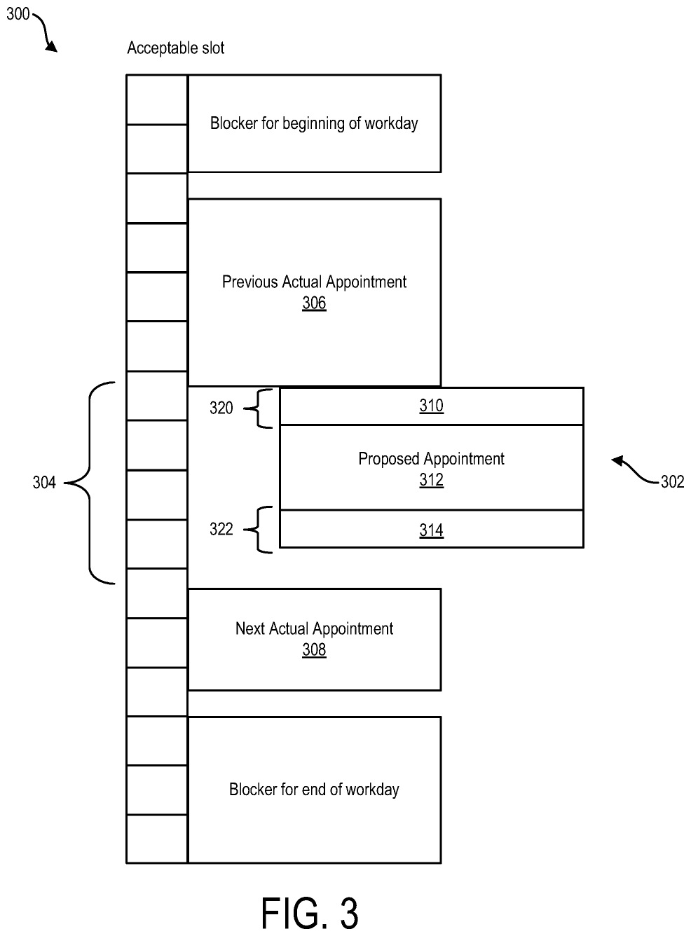

The estimation for the time taken to travel to the target location prior to the target assignment (e.g., the first travel time) and from the target location after the target assignment is completed (e.g., second travel time) can be estimated based on historical Global Positioning System (GPS) data. FIG. 3 is an exemplary illustration of a proposed comprehensive operation time for an available time slot in a service provider's calendar schedule. FIG. 3 illustrates that a comprehensive operation time 302 can be scheduled in the time slot 304 temporally located between a previous appointment 306 and a following appointment 308. The comprehensive operation time 302 includes a first travel time 310, an estimated operation time 312 and a second travel time 314. The first travel time 310 can be calculated based on historical GPS data (e.g., historical traffic data) for travelling from the first location of the previous appointment 306 to the target location at during a first portion 320 of the time slot 304. In some implementations, a forecasted traffic data can be used to calculate the first travel time 310. In some implementations, the forecasted traffic data can be calculated based on historical traffic data.

In some implementations, the first travel time 310 can be calculated by setting the temporal end of the previous appointment 306 as the beginning of the first travel time 310 time (or “depart by this time”). The second travel time 314 can be calculated based on historical GPS data for travelling from the target location to the second location of the following appointment 308 during a second portion 322 of the time slot 304. In some implementations, the second travel 314 time can be calculated by setting the temporal end of the proposed appointment 312 as the beginning of the second travel 314 (or “depart by this time”).

In some implementations, the first travel time 310 can be calculated by setting the temporal beginning of estimated operation time 312 as the end of the first travel time 310 (or “arrive by this time”). The second travel time 314 can be calculated based on historical GPS data for travelling from the target location to the second location of the following appointment 308 during a second portion 322 of the time slot 304. In some implementations, the second travel 314 time can be calculated by setting the temporal beginning of the following appointment 308 as the end of the second travel 314 (or “arrive by this time”).

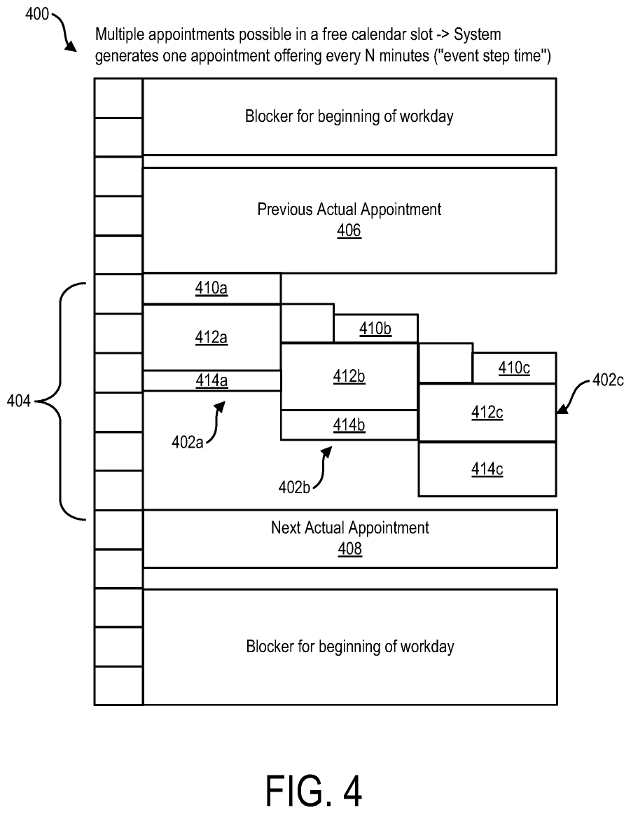

In some implementations, multiple proposed comprehensive operation times can be calculated for a given time slot. FIG. 4 is an exemplary illustration of multiple proposals for comprehensive operation times for an available time slot in a service provider's calendar schedule. FIG. 4 illustrates that proposals of comprehensive operation times 402a, 402b and 402c can be scheduled in the time slot 404 temporally located between a previous appointment 406 and a following appointment 408. The proposals of comprehensive operation times 402a, 402b and 402c can be temporally separated by a step time 416. In other words, if two proposals of comprehension operation times are made in a given time slot, the proposed comprehensive operation times can be separated by at least a step time (e.g., step time 416). The step time can be defined in service provider preferences. The comprehensive operation time 402a includes a first travel time 410a, an estimated operation time 412a and a second travel time 414a. The comprehensive operation time 402b includes a first travel time 410b, an estimated operation time 412b and a second travel time 414b. The comprehensive operation time 402c includes a first travel time 410c, an estimated operation time 412c and a second travel time 414c. Since the travel time associated with the different operation times occurs at different portions of the time slot 404, the travel time (e.g., travel time to the target location, travel time from the target location, etc.) can vary. In some implementations, the user can select the comprehensive operation time that corresponds to the smallest travel time.

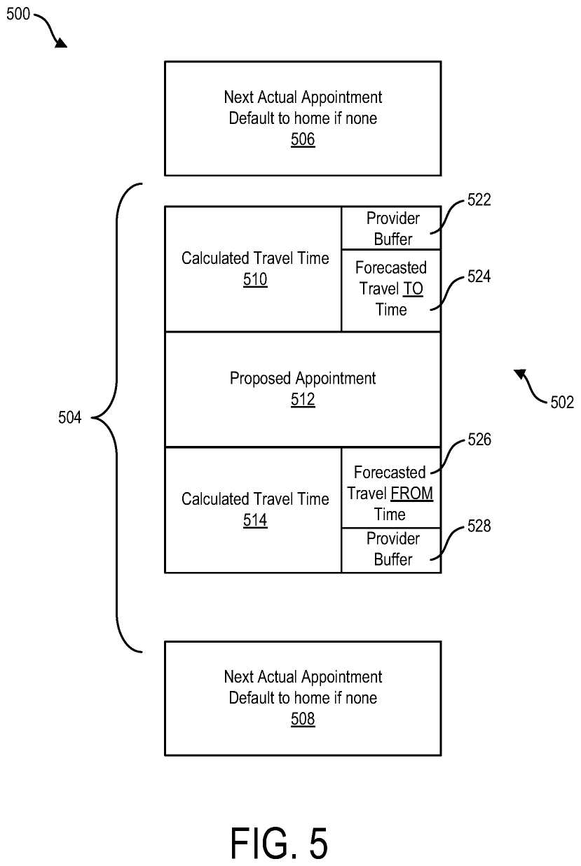

In some implementations, the comprehensive operation time can include travel buffer time that can be included in the service preferences provided by the first service provider. FIG. 5 is an exemplary illustration of a comprehensive operation time that includes travel buffer time. FIG. 5 illustrates that a proposed comprehensive operation time 502 can be scheduled in the time slot 504 temporally located between a previous appointment 506 and a following appointment 508. The comprehensive operation time 502 includes a first total travel time 510, an estimated operation time 512 and a second total travel time 514. The first total travel time 510 includes a first travel buffer time 522 (e.g., included in the service preferences) and a first travel time 524 (e.g., determined from GPS traffic data). The second total travel time 514 includes a second travel buffer time 528 (e.g., included in the service preferences) and a second travel time 524 (e.g., determined from GPS traffic data).

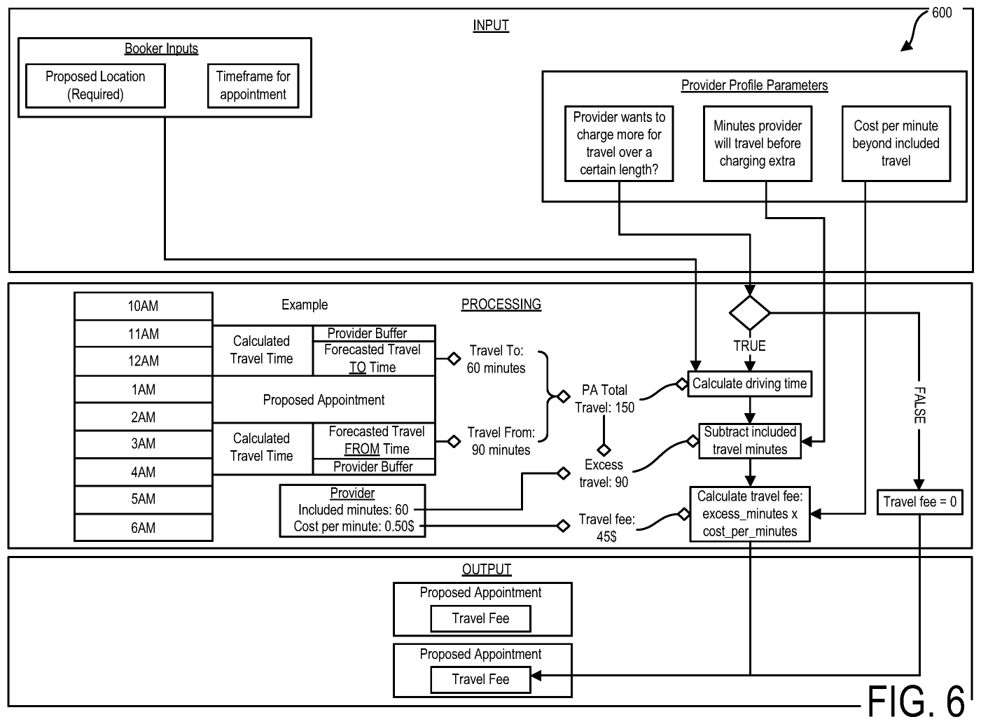

In some implementations, an operation cost associated with performing the target assignment can be determined. The determination of operation cost can be based on one or more of the estimated travel time, the estimated operation time, the target area, or the comprehensive operation time. FIG. 6 illustrates an exemplary schematic for determination of estimated travel fee associated with a travel time. The inputs for the travel fee determination algorithm can include information associated with the target assignment provided by the user (e.g., target location, a timeframe for performing the target assignment, etc.) and service preferences provided by the service provider (e.g., a threshold time below which no travel fee will be charged, travel cost per unit time (e.g., above the threshold time), travel fee brackets as a function of travel time, etc.). The travel fee calculation can include determination of the total travel time (e.g., time from the first location to the target location and time from the target location to the second location). In some implementations, a difference between the total travel time and the threshold time (e.g., indicative of free travel time) can be calculated, and the difference can be multiplied by the travel cost per unit time (e.g., provided by the service provider) to determine the travel fee.

In some implementations, the determination of operation cost can further include calculating a product of the target area (e.g., provided by the user) and the cost per unit target area (e.g., included in the service preferences of the service provider). In some implementation, the area based operating cost can be added to one or more of a base operating cost for performing the target assignment (e.g., included in the service preferences of the service provider) and the calculated travel fee to determine the overall operation cost.

Steps 102-106 can be repeated for multiple service providers (e.g., service providers selected from a plurality of service providers as discussed above), and comprehensive operation time and/or operation cost can be calculated for multiple service providers. Returning back to FIG. 1, at step 108, user can be notified with the information associated with the comprehensive operation time (e.g., as determined at step 106) and/or operation cost for one or more service providers. For example, the operation time and operation cost of the first service provider can be provided to the user. In some implementations, the user can get a notification that can include the length of the appointment (e.g., service provider's tentative time of arrival to and departure from the target location). In some implementations, the user can be provided with the basis of the calculation of travel fee (e.g., e.g., travel fee rates). In some implementations, the user may be notified of the estimated operation time rather than the comprehensive operation time (e.g., the estimated travel time may not be provided to the user).

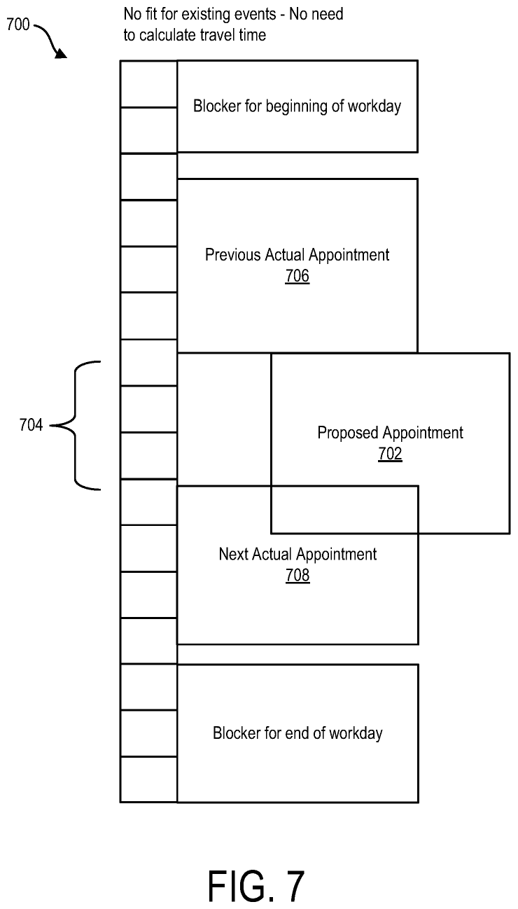

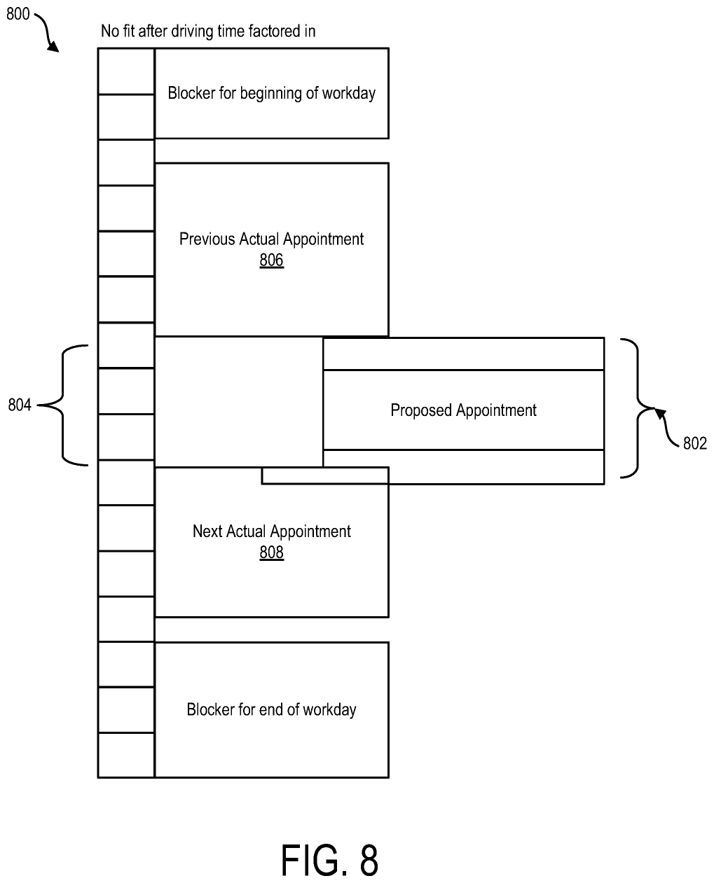

In some implementations, the estimated operation time can have a time duration greater than the time slot. As a result, the time slot can be deemed to be unsuitable for the target assignment and discarded. For example, the time slot can be discarded without calculating the travel time. FIG. 7 is an exemplary illustration of a proposed operation time 702 having a time duration greater than the time slot 704 temporally located between a previous appointment 706 and a following appointment 708. In some implementations, if the estimated operation time has a time duration less than the time slot, an estimated travel time to and from the target location can be calculated. If the comprehensive operation time that includes the estimated operation time and the estimated travel time has a time duration greater than the time slot, the time slot can be deemed to be unsuitable for the target assignment and discarded. FIG. 8 is an exemplary illustration of a proposed comprehensive operation time 802 having a time duration greater than the time slot 804 temporally located between a previous appointment 806 and a following appointment 808. If the time slot(s) associated with a service provider (e.g., first service provider) within the user's time frame for performing the target assignment does not accommodate the comprehensive operation time, the user can be notified that the service provider is incapable of performing the target assignment. Alternately, if the time slot(s) associated with a service provider (e.g., first service provider) can accommodate the comprehensive operation time, the user can be notified that the service provider is capable of performing the target assignment.

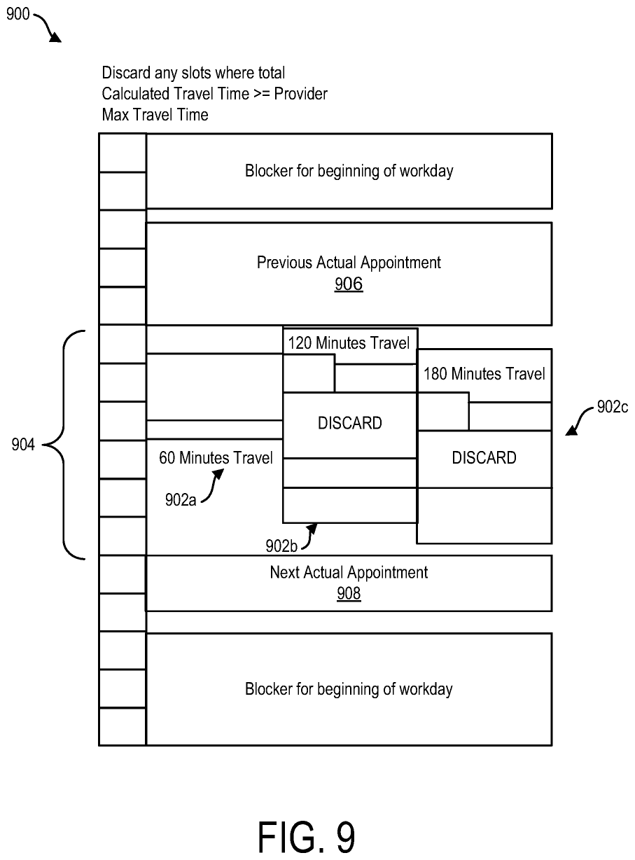

In some implementations, when multiple proposed comprehensive operation times are calculated for a given time slot, one or more of the proposed comprehensive operation time that have a travel time greater than a predetermined threshold travel time (e.g., included in the service provider preferences) can be discarded. FIG. 9 is an exemplary illustration of multiple proposals for comprehensive operation times for an available time slot. FIG. 9 illustrates that comprehensive operation times 902a, 902b and 902c are calculated for the time slot 904 that is temporally located between a previous appointment 906 and a following appointment 908. The travel time associated with the operation times 902a, 902b and 902c is 60 minutes, 120 minutes and 180 minutes, respectively. If the threshold travel time is set to 100 minutes, comprehensive operation times 902b and 902c can be discarded. Alternately, if the threshold travel time is set to 150 minutes comprehensive operation time 902c can be discarded. Alternately, if the threshold travel time is set to 200 minutes, none of the comprehensive operation times can be discarded.

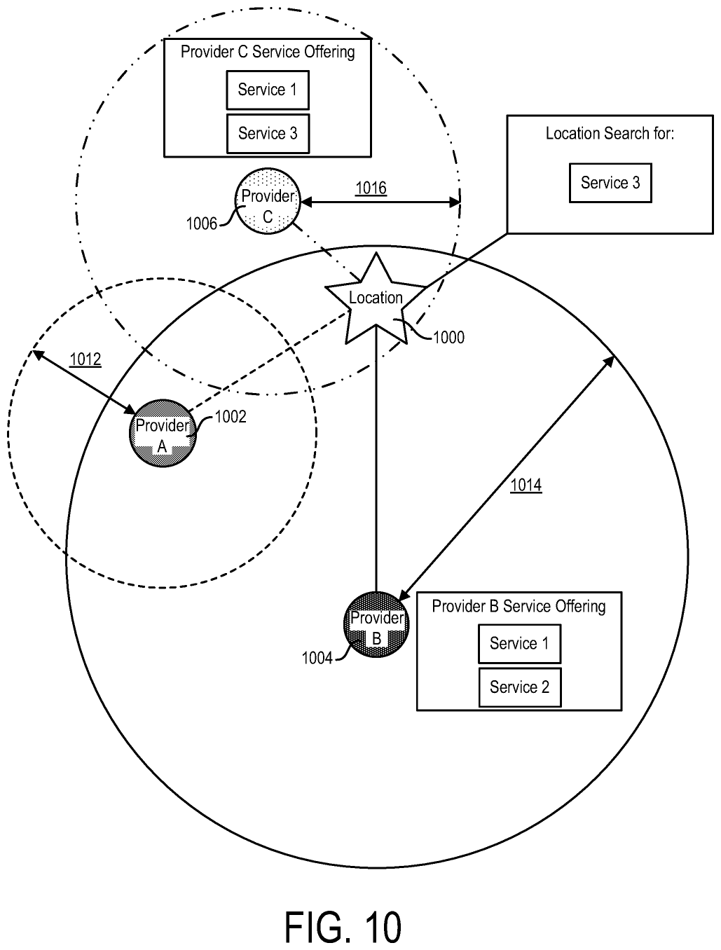

In some implementations, one or more service providers can be selected from available service providers prior to calculation of estimated travel time, estimated operation time, etc. The selection can be based on maximum travel distances associated with the service providers (e.g., included in the service preferences). FIG. 10 illustrates exemplary selection of service providers for a target location 1000 based on maximum travelling distances associated with the selection providers. As illustrated in FIG. 10, a first service provider 1002 has a first maximum travel distance 1012, a second service provider 1004 has a first maximum travel distance 1014, and a third service provider 1006 has a third maximum travel distance 1016. Because the distance between the first provider 1002 and the target location 1000 is greater than the first maximum travel distance 1012 of the first provider 1002, the first provider can be discarded. The service providers can be discarded based on the service that they are providing. In other words, service providers that do not provide the type of target assignment associated with location 1000 can be discarded. For example, if the target assignment type associated with location 1000 is “Service 3” and the second service provider 1004 provides services of types “Service 1” and “Service 2” but not “Service 3,” the second service provider 1004 can be discarded. In some implementations, if both maximum travel distance and target assignment type constraints are applied to FIG. 10, the first service provider 1002 and the second service provider 1004 can be discarded and information associated with the third service provider 1006 can be presented to the user associated with the target location 1000.

In some implementations, if multiple service providers have been selected based on the constraints (e.g., maximum travel distance, maximum travel time, target assignment type, etc.), the selected service providers can be ranked and the ranking can be presented to the user. For example, the selected service providers can be ranked based on rating, experience (e.g., total number of jobs), insurance information, tentative cost of performing the target assignment, proximity (e.g., travel distance), etc., associated with the selected service providers. In some implementations, the user can select the property for ranking the service providers.

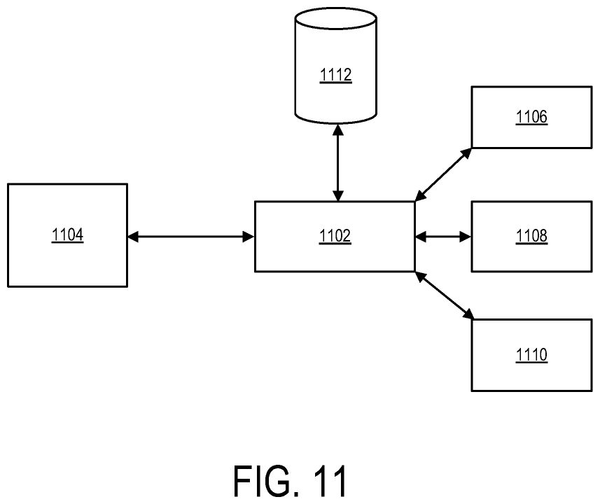

In some implementations, the methods described above (e.g., steps 102-108) can be implemented by a computing device (e.g., by a processor in a computing device). FIG. 11 illustrates an exemplary computation device 1102 for scheduling a service appointment. As illustrated in FIG. 11, the computing device 1102 can be in communication with a user's device 1104. In some implementation, the computing device 1102 can be a cloud-based service. The computing device 1102 can receive data from the user (e.g., data characterizing target assignment, target assignment type, target area, timeframe for scheduling the target assignment etc.), and provide scheduling information to the user (e.g., comprehensive operation time, estimated travel time, estimated operation time, operation cost, travel cost, etc.) to the user. In some implementations, the computing device 1102 can communicate with one or more service providers' devices 1106-1110. For example, the computing device can retrieve the calendar schedule of the service provider from the service providers' devices 1106-1110. In some implementation the calendar schedule of the service provider can be stored and hosted by the computing device 1102 (or a cloud-based service). For example, the calendar schedule can be stored in a database 1112 associated with the computing device 1102. The service providers can decide whether to use a third party calendar service (from which the calendar schedule can be retrieved) or use a calendar service provided by the computing device 1102. In some implementations, the database 1112 can store various information associated with the user and the service provider (e.g., service provider preferences, service providers' calendar schedule, etc.). The computing device can retrieve the aforementioned information from the database 1112 and store the computed information (e.g., comprehensive operation time, estimated travel time, estimated operation time, operation cost, travel cost, etc.) in the database 1112.

Certain exemplary embodiments are described herein to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method of automatically scheduling a service provider appointment at a target location, the method comprising the steps of:
receiving, by a data processor, data characterizing a first calendar schedule of a first service provider, and data characterizing a target assignment that includes a target area, a target assignment type, and the target location;
identifying, by the data processor, a first time slot in the first calendar schedule, wherein the first time slot is temporally located between a previous appointment located at a first location and a following appointment located at a second location;
determining, by the data processor, a comprehensive operation time associated with the target assignment and the first service provider based on at least an estimated travel time including a first travel time from the first location to the target location and a second travel time from the target location to the second location, and an estimated operation time to perform the target assignment based on the target area and the target assignment type; and
providing, by the data processor, the comprehensive operation time.

2. The method of claim 1, further comprising the steps of:
receiving, by the data processor, data characterizing calendar schedules and service preferences associated with a plurality of service providers, wherein the plurality of service providers include the first service provider;
selecting, by the data processor, the first service provider from the plurality of service providers based on a first set of service preferences associated with the first service provider, wherein the first set of service preferences includes at least one of a maximum travel time, a maximum travel distance, an operation cost, or an operating schedule associated with the first service provider.

3. The method of claim 2, wherein selecting the first service provider further includes determining that the first travel time from the first location to the target location or a second travel time from the target location to the second location is below a preferred travel time included in the first set of service preferences.

4. The method of claim 2, further comprising the steps of:
determining, by the data processor, an operation cost associated with performing the target assignment based on one or more of the estimated travel time, the estimated operation time, the target area, or the comprehensive operation time; and
providing, by the data processor, the operation cost.

5. The method of claim 4, wherein determining the operation cost includes:
determining a product of a difference between the estimated travel time and a free travel time, as multiplied by a cost per travel time, and
determining a product of the target area and a cost per unit target area, wherein the first set of service preferences include the free travel time, the cost per travel time and the cost per unit target area.

6. The method of claim 2, wherein determining the comprehensive operation time further includes determining that a distance between the target location and the first location is less than a preferred travel distance of the first set of service preferences.

7. The method of claim 1, wherein providing the comprehensive operation time includes providing a notification to a user that the first provider is incapable of performing the target assignment when the comprehensive operation time is greater than a length of time of the first time slot, or providing a notification to a user that the first provider is capable of performing the target assignment when the comprehensive operation time is less than the length of time of the first time slot.

8. The method of claim 1, wherein the first travel time from the first location to the target location is based on a first predetermined time as measured by historical Global Positioning System (GPS) traffic data from the first location to the target location during a first portion of the first time slot, and wherein the second travel time from the target location to the second location is based on a second predetermined time as measured by historical GPS data from the target location to the second location during a second portion of the first time slot.

9. The method of claim 8, wherein the estimated travel time includes at least one of a first travel buffer time prior to the first travel time or a second travel buffer time after the second travel time.

10. The method of claim 1, wherein the estimated operation time to perform the target assignment includes a base operation time and a target-area-based operation time, wherein the base operation time is associated with the target assignment type, and wherein the target-area-based operation time is a product of the target area and a time per unit target area.

11. A system comprising:
at least one data processor;
a memory coupled to the at least one data processor, the memory storing instructions to cause the at least one data processor to perform operations comprising:
receiving data characterizing a first calendar schedule of a first service provider, and data characterizing a target assignment that includes a target area, a target assignment type, and the target location;
identifying a first time slot in the first calendar schedule, wherein the first time slot is temporally located between a previous appointment located at a first location and a following appointment located at a second location;
determining a comprehensive operation time associated with the target assignment and the first service provider based on at least an estimated travel time including a first travel time from the first location to the target location and a second travel time from the target location to the second location, and an estimated operation time to perform the target assignment based on the target area and the target assignment type; and
providing the comprehensive operation time.

12. The system of claim 11, wherein the operations further comprising:
receiving data characterizing calendar schedules and service preferences associated with a plurality of service providers, wherein the plurality of service providers include the first service provider;
selecting the first service provider from the plurality of service providers based on a first set of service preferences associated with the first service provider, wherein the first set of service preferences includes at least one of a maximum travel time, a maximum travel distance, an operation cost, or an operating schedule associated with the first service provider.

13. The system of claim 12, wherein selecting the first service provider further includes determining that the first travel time from the first location to the target location or a second travel time from the target location to the second location is below a preferred travel time included in the first set of service preferences.

14. The system of claim 12, wherein the operations further comprising:
determining an operation cost associated with performing the target assignment based on one or more of the estimated travel time, the estimated operation time, the target area, or the comprehensive operation time; and
providing the operation cost.

15. The system of claim 14, wherein determining the operation cost includes:
determining a product of a difference between the estimated travel time and a free travel time, as multiplied by a cost per travel time, and
determining a product of the target area and a cost per unit target area, wherein the first set of service preferences include the free travel time, the cost per travel time and the cost per unit target area.

16. The system of claim 12, wherein determining the comprehensive operation time further includes determining that a distance between the target location and the first location is less than a preferred travel distance of the first set of service preferences.

17. The system of claim 11, wherein notifying the comprehensive operation time includes providing a notification to a user that the first provider is incapable of performing the target assignment when the comprehensive operation time is greater than a length of time of the first time slot, or providing a notification to a user that the first provider is capable of performing the target assignment when the comprehensive operation time is less than the length of time of the first time slot.

18. The system of claim 11, wherein the first travel time from the first location to the target location is based on a first predetermined time as measured by historical Global Positioning System (GPS) traffic data from the first location to the target location during a first portion of the first time slot, and wherein the second travel time from the target location to the second location is based on a second predetermined time as measured by historical GPS data from the target location to the second location during a second portion of the first time slot.

19. The system of claim 18, wherein the estimated travel time includes at least one of a first travel buffer time prior to the first travel time or a second travel buffer time after the second travel time.

20. The system of claim 11, wherein the estimated operation time to perform the target assignment includes a base operation time and a target-area-based operation time, wherein the base operation time is associated with the target assignment type, and wherein the target-area-based operation time is a product of the target area and a time per unit target area.

21. A computer program product comprising a machine-readable non-transitory medium storing instructions that, when executed by at least one programmable processor, cause the at least one programmable processor to perform operations comprising:
receiving data characterizing a first calendar schedule of a first service provider, and data characterizing a target assignment that includes a target area, a target assignment type, and the target location;
identifying a first time slot in the first calendar schedule, wherein the first time slot is temporally located between a previous appointment located at a first location and a following appointment located at a second location;
determining a comprehensive operation time associated with the target assignment and the first service provider based on at least an estimated travel time including a first travel time from the first location to the target location and a second travel time from the target location to the second location, and an estimated operation time to perform the target assignment based on the target area and the target assignment type; and
providing the comprehensive operation time.

22. The computer program product of claim 21, wherein the operations further comprising:
receiving data characterizing calendar schedules and service preferences associated with a plurality of service providers, wherein the plurality of service providers include the first service provider;
selecting the first service provider from the plurality of service providers based on a first set of service preferences associated with the first service provider, wherein the first set of service preferences includes at least one of a maximum travel time, a maximum travel distance, an operation cost, or an operating schedule associated with the first service provider.

23. The computer program product of claim 22, wherein selecting the first service provider further includes determining that the first travel time from the first location to the target location or a second travel time from the target location to the second location is below a preferred travel time included in the first set of service preferences.

24. The computer program product of claim 22, wherein the operations further comprising:
determining an operation cost associated with performing the target assignment based on one or more of the estimated travel time, the estimated operation time, the target area, or the comprehensive operation time; and
providing the operation cost to the user.

25. The computer program product of claim 24, wherein determining the operation cost includes:
determining a product of a difference between the estimated travel time and a free travel time, as multiplied by a cost per travel time, and
determining a product of the target area and a cost per unit target area, wherein the first set of service preferences include the free travel time, the cost per travel time and the cost per unit target area.

26. The computer program product of claim 22, wherein determining the comprehensive operation time further includes determining that a distance between the target location and the first location is less than a preferred travel distance of the first set of service preferences.

27. The computer program product of claim 21, wherein notifying the comprehensive operation time includes providing a notification to a user that the first provider is incapable of performing the target assignment when the comprehensive operation time is greater than a length of time of the first time slot, or providing a notification to a user that the first provider is capable of performing the target assignment when the comprehensive operation time is less than the length of time of the first time slot.

28. The computer program product of claim 21, wherein the first travel time from the first location to the target location is based on a first predetermined time as measured by historical Global Positioning System (GPS) traffic data from the first location to the target location during a first portion of the first time slot, and wherein the second travel time from the target location to the second location is based on a second predetermined time as measured by historical GPS data from the target location to the second location during a second portion of the first time slot.

29. The computer program product of claim 28, wherein the estimated travel time includes at least one of a first travel buffer time prior to the first travel time or a second travel buffer time after the second travel time.

30. The computer program product of claim 21, wherein the estimated operation time to perform the target assignment includes a base operation time and a target-area-based operation time, wherein the base operation time is associated with the target assignment type, and wherein the target-area-based operation time is a product of the target area and a time per unit target area.
